(19) United States
(12) Patent Application Publication
(10) Pub. No.: US 2002/0044284 A1
(43) Pub. Date: Apr. 18, 2002

(54) Laser and workpiece alignment device

(76) Inventor: James Webb, Torrance, CA (US)

Correspondence Address: Roger A. Marrs, Suite 1120, 15233 Ventura Blvd., Sherman Oaks, CA, 91403, US

(21) Appl. No.: 09/978,989

(22) Filed: Oct. 16, 2001

Related U.S. Application Data
(60) Provisional application No. 60/239,973, filed on Oct. 16, 2000.

(51) Int. Cl. G01B 11/00

(52) U.S. Cl. 356/399

(57) ABSTRACT

An alignment device utilizing a laser beam generator mounted in the end of a fixture which is detachably connected to a turning spindle or mechanism by an adjustable chuck or clamp. The fixture includes an elongated longitudinal axis which is parallel with the turning axis of the rotating spindle when the fixture is attached thereto. The laser generator produces a beam which is emitted along the longitudinal axis of the fixture or alternately emitted along a lateral axis and places a visual dot along the table or platform on which the workpiece supporting cradle or carriage moves. The workpiece is detachably connected to the cradle and the cradle is moved laterally or longitudinally with respect to the longitudinal axis emitted laser beam until a desired location is achieved. A movable yoke is pivotally carried on the fixture which includes a central recess defined between parallel leg members terminating in ends pivotally carried on the mid-section of the fixture. The opposite end of the yoke includes an aperture passing the laser beam. A variety of selected lens types may be mounted in the aperture. The yoke is pivoted laterally to align the lateral generated laser beam to be conducted along the lateral axis through the aperture in the yoke.

### BACKGROUND OF THE INVENTION

1. Field of the Invention

The present invention relates to the field of workpiece alignment devices and more particularly to a novel laser generator mounted on a turning spindle head for aligning a workpiece intended to be machined and which is carried on a workpiece cradle or table.

2. Brief Description of the Prior Art

In the past, it has been the conventional practice to place a workpiece on a movable cradle carried on a table such as a table or platform movably installed on a lathe or the like. The cradle carrying the workpiece is moved both laterally and longitudinally on the work table in order to properly locate the workpiece beneath a turning tool such as a drill or the like. Preparatory for an actual drilling location, it is important that the workpiece be properly aligned with respect to the axis of the turning spindle head which carries the cutting tool. Typical pre-alignment tools take the form of sensitive probes or other indicators which engage with surfaces to be aligned, centered or calibrated.

Problems and difficulties have been encountered when using such conventional probes or indicators which stem largely from the fact that the alignment procedure is very time consuming and labor intensive and if not performed in a careful manner, damage to either the workpiece or the indicator or probe can occur. Also, it is not practical to return the spindle head back to zero or perpendicular to the cradle or table surface. This return process involves lengthy instrument calibration relative to the supporting bed or vise weighs in an attempt to bring the spindle to exact perpendicular position for calibration and further machining.

Therefore, a long-standing need has existed to provide a novel alignment device which is useful in pre-aligning a spindle with respect to a table or a given location without the risk of the indicator instrument being in the path of harm and damage. Preferred is an alignment device which does not touch nor engage in contact with the workpiece in order to determine alignment.

### SUMMARY OF THE INVENTION

Accordingly, the above problems and difficulties are avoided by the present invention which provides a novel alignment device utilizing a laser beam generator mounted in a fixture which is detachably connected to a turning mechanism by means of an adjustable chuck or other clamping means. The fixture includes an elongated longitudinal axis which is parallel with the turning axis of the machine spindle when the fixture is attached to the turning means. The laser generator produces a beam which is emitted on the longitudinal axis of the fixture and is intended to place a visual dot along the table or platform on which the movable workpiece supporting carriage moves. The workpiece is detachably connected to the cradle and the cradle is moved laterally or longitudinally with respect to the longitudinal axis emitted laser beam so that a desired location is achieved.

A feature of the invention further includes a movable yoke pivotally carried on the fixture which includes a central recess defined between parallel leg members which have terminating ends pivotally carried on the mid-section of the fixture. During the alignment procedure, the yoke member may be rotated to a lateral position so as not to interfere with either an emitted laser beam along the longitudinal axis or through a lateral opening. The lateral opening permits passage of a lateral or transverse generated laser beam to pass through the recess between the leg members when the yoke member is positioned so as to downwardly depend from the fixture.

Once alignment has been achieved, the yoke member may be employed for mounting a cutting tool or other tool to complete a machine operation on the workpiece, or, if desired, the fixture and yoke may be removed as a unit from the spindle of the turning means and a cutting tool or the like may be installed thereon.

Therefore, it is among the primary objects of the present invention to provide a laser beam adjustment and alignment means in a system which brings turning spindle heads together or in alignment with a part to be machined by physically moving each of the respective components until a very sensitive indicator or cutting tool comes into contact with the surfaces to be aligned, centered, calibrated, or machined.

Another object of the present invention is to provide a novel laser beam alignment device which incorporates the use of an aligned laser tool held by a tool holder to pre-align or quickly move the spindle or table to a given location without the risk of the indicator instrument itself being in the path of harm or damage.

Still another object of the present invention is to provide a laser beam generator as a visual indicator whereby the operator of a machine can quickly move to a selected, targeted position, and bring the actual instrument into use for calibration without fear that the indicator will be damaged.

Still a further object resides in providing a visual beam generated from a laser generator which allows for quick movement and pre-alignment to any selected location for tooling or jig placement.

Yet another object resides in providing an alignment device utilizing a laser beam which is capable of returning a spindle head to zero or to a perpendicular alignment with respect to the surface of a vise or worktable.

Still a further object resides in providing an alignment device for mounting on a turning spindle and which includes a two-way lens whereby an operator may actuate the laser quickly in order to visually observe the rotation of the laser beam generator to adjust the spindle head to any given alignment axis necessary.

Yet a further object resides in providing an alignment device using a laser beam where an operator can easily and quickly bring the machine head to a perpendicular approximation with respect to a workpiece cradle thereby allowing the use of an actual calibration instrument only when needed.

Another object resides in providing a laser beam alignment device having a fixture mounted to a turning spindle and carrying a laser generator emitting either a beam along a longitudinal axis or along a lateral axis and which includes a yoke member having a lens thereon for conducting transmission of the beam along either axis.

Also, an object includes the provision of an extension outwardly projecting from a spindle having a cantilevered end mounting a laser beam alignment device.

### BRIEF DESCRIPTION OF THE DRAWINGS

The invention, its configuration, construction and operation will be best further described in the following detailed description, taken in conjunction with the accompanying drawings in which:

FIG. 1 is a front perspective view illustrating the novel laser beam alignment device used in connection with aligning a workpiece with respect to a work table or platform which utilizes the present invention;

FIG. 2 is side-elevational view taken from the end of a supporting worktable illustrating the laser beam alignment device capable of generating a longitudinal beam as well as a transverse or lateral beam;

FIG. 3 is a front-elevational view of the alignment device illustrating indicator probe positioned into a storage or standby position;

FIG. 4 is an enlarged elevational view of the laser beam alignment device and illustrating the indicator probe in a downwardly depending position in solid lines and a lateral position shown in broken lines;

FIG. 5 is an enlarged perspective view of the laser beam alignment device which is utilized in the means shown in FIGS. 1 - 4 inclusive;

FIG. 6 is an exploded perspective view of the laser beam alignment device shown in FIG. 5;

FIG. 7 is a view similar to the view of FIG. 1 illustrating the laser beam alignment device and having the indicator probe extended for lateral adjustment;

FIG. 8 is an enlarged side elevational view of the laser beam generator shown in FIG. 7 with a portion broken away to illustrate a passageway for laser beam conduction; and

FIG. 9 is a reduced perspective view showing the laser beam alignment device and a laterally extendable arm for extended probe or indicator positioning.

### DESCRIPTION OF PREFERRED EMBODIMENT

Referring to FIG. 1, the novel laser beam alignment device is illustrated in the general direction of arrow 10 which includes a fixture 11 on which a yoke member 12 is pivotally mounted. A laser beam generator 13 is included and downwardly depends from the fixture 11. The opposite end of the fixture is mounted into a turning device such as a spindle 14 and is detachably connected therewith by an adjustable chuck 15. The spindle 14 is connected to a powered turning means broadly indicated by numeral 16 carried on the end of a machine arm 17. It is to be understood that the turning means is not a part of the present invention.

A workpiece 20 is mounted between jaws 21 and 22 provided on a carriage or cradle 23. The carriage or cradle 23 may be moved in a longitudinal direction across the top of a table ways or platform 24 in accordance with arrows 25. The carriage may also be moved in a transverse or lateral direction in accordance with arrows 26. Movement either in a longitudinal or in a lateral direction is achieved by manually operated controls 27 and 28 respectively. The table 24 is mounted on a supporting base or table 30.

The laser generating means 13 emits a linear beam 31 which is coextensive with respect to the central longitudinal axis of the fixture 11. The beam is represented by numeral 31 and terminates in a dot 32 on the surface of table 24. It is noted that the yoke member 12 has two positions and has been moved into an alternative position in this-instance by rotating the member laterally so that the port 19 of the laser beam generator 13 is exposed to permit emission of the beam 31, while a lateral port 29 is exposed to emit a transversion lateral beam 33 shown in FIG. 2.

Referring now in detail to FIG. 2, it can be seen that the laser beam generator 13 emits beam 31 from a port 19 along the longitudinal axis of the fixture 11. Also, it can be seen that a lateral port 29 on the generator permits the emission of a lateral beam indicated by numeral 33 which terminates in a dot 34 against a vertical structure. The object against which beam 33 terminates is not illustrated; however, it is to be understood that the dot 34 terminates to the side of the workpiece 20 so as to provide an alignment location. It can also be seen that the turning means 16 can be pivotally located as indicated by numeral 35. The longitudinal axis of the fixture 11 and the turning means is indicated by numeral 36. The view taken in FIG. 2 illustrates that the vertical longitudinal beam 31 may be employed for locating the sides of the workpiece 20 so as to be laterally disposed with respect to the surface of table 24. It can be seen that the distance between the top of the workpiece and the transverse generated beam 33 can also be determined and indicated depending on the termination point 34 on the remote lateral target (not shown).

In FIG. 3, it can be seen that the opposite ends of the workpiece 20 can be located with respect to the surface table 21 by means of the emitted beam 31 and the top distance by the lateral or transverse beam 33. The yoke member 12 is positioned to its non-operative position, in this instance, by pivoting upwardly on the fixture 11. For illustrative purposes, the yoke member 12 carries a mechanical probe indicator 35 which may be used for the final alignment determination. However, the laser beam generator incorporating the present invention is for pre-alignment purposes in the present illustration.

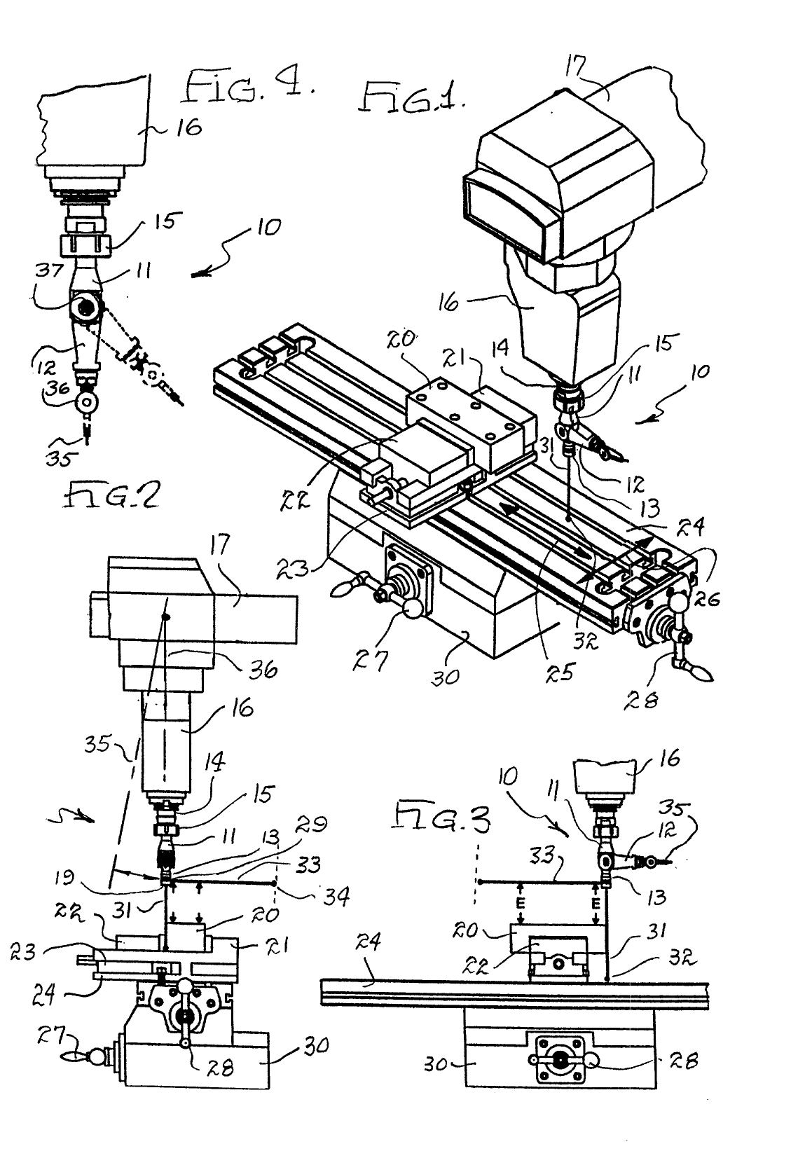

In FIG. 4, it can be seen that the yoke member 12 may be positioned from its lateral operative position as shown in broken lines to its alternative operative position shown in solid lines so that the probe indicator 35 lies on the central longitudinal axis 36 of the turning mechanism or means. A suitable micrometer or the like is illustrated in general by the numeral 35 which can be employed for measurement and calibration purposes. A pivot 37 rotatably mounts the yoke member 12 to the mid-section of the fixture 11.

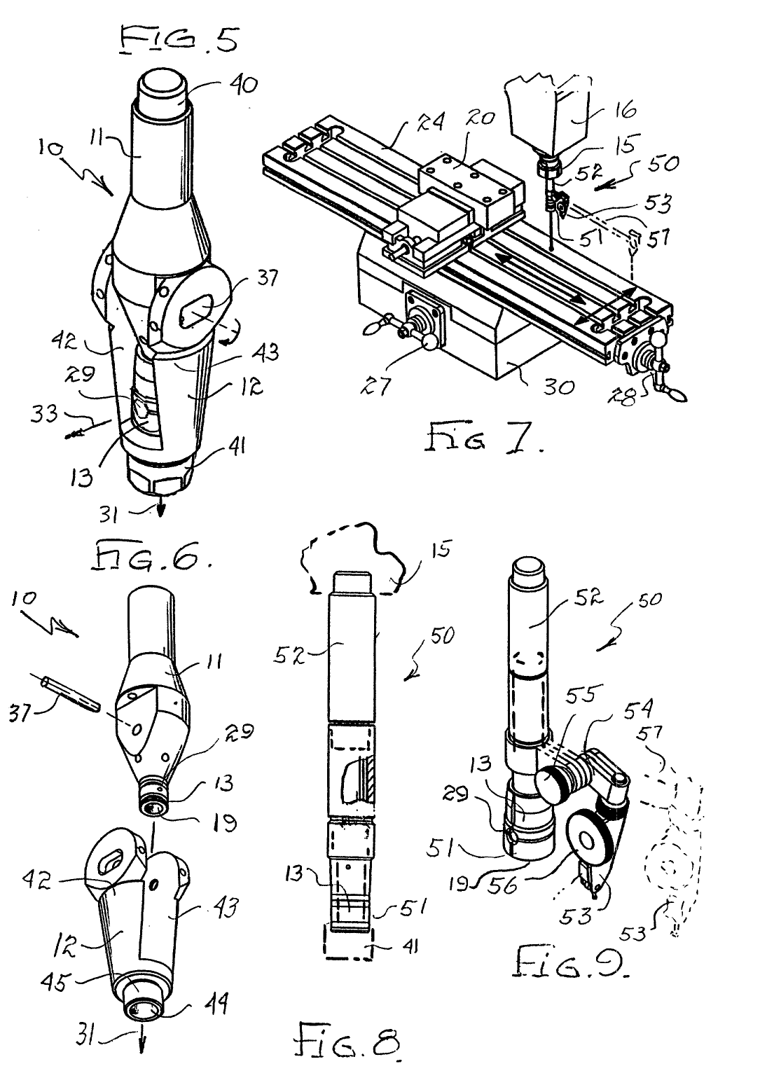

Referring now in detail to FIGS. 5 and 6, the laser alignment means 10 includes a mounting stud 40 that is carried on one end of the fixture 11 for detachable connection with the chuck 15 of the turning means. The opposite end of the fixture includes mounting for the laser generator 13 which not only includes an end port 19 for emitting longitudinal beam 31, but which further includes a lateral port 29 for emitting the lateral beam 33. When the yoke member 12 is in its first operative position, beam 31 is emitted through port 19 of the yoke member 12. A receptacle or recess is defined between the opposing surfaces of the leg members 42 and 43 in which the laser beam generator 13 resides so that the ports 19 and 29 are exposed. Therefore, when the yoke member 12 is rotated to its first or second operative position, all of the ports are still open for laser beam emission. As seen in FIG. 6, the terminating end of yoke member 12 includes an open port 44 through which the beam 31 may pass. The port 44 is within a collar 45 that may be used to mount a tool such as an indicator, a probes a lens or even a cutting tool as represented by numeral 35 in the aforementioned FIGURES. Also, a variety of different lens types may be mounted such as a line lens, two-way lens or the like, as represented by numeral 41 in FIG. 5.

Referring now to FIGS. 7 - 9 inclusive, another version of the laser beam alignment means is illustrated in the general direction of arrow 50 which includes a laser beam generator 51 mounted on the end of a fixture 52. An indicator or probe 53 is also carried on fixture 52 and it is important to note that the indicator or probe 53 is extendable in a lateral or transverse direction in cantilevered fashion by a mount 49 coupled to the fixture. As illustrated in broken lines in FIGS. 7 and 9, the probe or indicator 53 may be extended laterally on an extendable mechanism 54. A tightening screw 55 may be used to retain the probe or indicator 53 in its extended position. The indicator may also include a micrometer setting which is operable by the wheel 56. The probe or indicator 53 may be raised or lowered accordingly to a selected position by the operator.

FIGS. 7 and 9 illustrate that the indicator 53 is carried on the end of an extension arm 57 so as to be positionable sideways for a selected distance.

Accordingly, it can be seen that the novel laser alignment means of the present invention incorporates the use of an aligned laser tool which is held by a conventional tool holder for pre-aligning or quickly moving the spindle or table to a given location without the risk of the indicator or probe instrument itself being in the path of harm. By using the laser beam as a visual indicator, the operator can quickly move to his targeted position and bring an actual cutting instrument into use for calibration without the fear of damage that is usual in the alignment process. The visual laser beam, either down and sideways, also allows for quick movement and pre-alignment to any given location for tooling of jig placement. Another use and application for the present invention is that of “bringing in” or returning a spindle head back to zero which means perpendicular to a vise or table surface. The present invention when used with a turning spindle and when the two-way lens is attached, the operator can turn on the laser and quickly, visually, rotate the indicator to quickly adjust the spindle head to any selected alignment needed. By having a perfect and rotary length of straight sight, employing the laser beam, the operator can easily and quickly bring the machine heads to perpendicular approximation thereby allowing the use of the actual calibration instrument only when needed. The laser beam visual process incorporating the present invention has the advantage of allowing the operator to utilize location control on a large bridgemill, for example, or sized machinery where large distances exist between the tooling and the workpieces.

The laser beam generator can accommodate several lens caps to re-direct, square up, or give line generation to the laser dot. Many lenses of different types can be incorporated such as line lens, two-way lens, etc. to each style. For some applications, the indicator can be moved or toggled from side-to-side. When toggled sideways, it exposes the laser beam and automatically turns the laser on while still clearing any type of lens option. When the operator is “on mark” with the laser dot, the operator simply toggles the indicator down which has the micrometer attached for touch calibration.

While particular embodiments of the present invention have been shown and described, it will be obvious to those skilled in the art that changes and modifications may be made without departing from this invention in its broader aspects and, therefore, the aim in the appended claims is to cover all such changes and modifications as fall within the true spirit and scope of this invention.

What is claimed is:

1. A workpiece and work surface alignment device comprising:
a turning means having a longitudinal axis;
a fixture detachably mounted with said turning means;
a laser beam generator mounted on said fixture and having a first port coaxially disposed with respect to said longitudinal axis and a second port having a transverse axis normal to said longitudinal axis; and
a member pivotally mounted on said fixture having an aperture for selectively aligning with said first port or said second port so as to simultaneously permit a generated laser beam to emit laterally from said second port and longitudinally from said first port.

2. The alignment device defined in claim 1 wherein:
said member is a yoke member having a pair of parallel legs defining a recess therebetween for movably receiving said fixture and said laser beam generator.

3. The alignment device defined in claim 2 wherein:
said yoke member is elongated having a pivot connection with said fixture; and
said yoke member being pivotal between a first position with said aperture lying on said longitudinal axis coaxially disposed with respect to said first port and said fixture and a second position normal to said longitudinal axis in alignment with said second port.

4. The alignment device defined in claim 3 including:
a collar carried on said yoke member about said aperture; and
a work tool detachably connected with said collar.

5. The alignment device defined in claim 3 including:
a collar carried on said yoke member about said aperture; and
a lens detachably coupled with said collar.

6. The alignment device comprising:
an elongated fixture having opposite ends;
coupling means carried on one end of said fixture;
a laser beam generator carried on the other end of said fixture;
said laser beam generator having a pair of beam emitting ports with each port having a beam axis; and
said beam axises being normal with respect to each other for simultaneously conducting laser beams along a central longitudinal axis of said fixture and along a lateral axis of said fixture.

7. The laser alignment device defined in claim 6 further including:
a tool holder having a selected end pivotally coupled to said fixture and a non-selected end provided with a coupling collar; and
said tool holder having an aperture in said non-selected end and said collar for conducting either laser generated beam from said pair of ports when aligned therewith.

8. The laser alignment device defined in claim 7 including:
an indicator implement detachably coupled with said collar and extending along said central longitudinal axis.

9. The laser alignment device defined in claim 8 including:
an extension arm having a pair of ends of which one end is detachably connected to said fixture and another end laterally disposed of said fixture terminating in a connection with said indicator implement.

10. The laser alignment device defined in claim 7 wherein:
said tool holder is a yoke member having a central recess defined by a pair of parallel legs with said fixture occupying said recess; and
pivot means movably coupling said pair of legs with said fixture to permit said fixture to at least 90° between said pair of legs.

11. A laser beam alignment device comprising:
a fixture;
a laser beam generator mounted on said fixture;
said laser beam generator having a first beam emitting port and a second beam emitting port; and
said first beam emitting port facing at a right angle to the facing of said second beam emitting port so that a direction normal to the direction of a longitudinal laser beam emitting from said first beam emitting port.

12. The laser beam alignment device defined in claim 11 including:
a tool holder pivotally mounted and said fixture uninhibiting said first and said second ports; and
a tool detachably mountable on said tool holder and pivotal therewith.

13. The laser beam alignment device defined in claim 12 including:
an extension arm adjustably mounting said tool holder to said fixture; and
said tool mounted on said holder via said arm.
